(19) United States
(12) Patent Application Publication
(10) Pub. No.: US 2023/0394467 A1
(43) Pub. Date: Dec. 7, 2023

(54) SYSTEM AND METHOD FOR PROVIDING RESTRICTED TOKEN USAGE DURING AN ONBOARDING PHASE

(71) Applicant: The Toronto-Dominion Bank, Toronto (CA)

(72) Inventor: Luc-Elysee KAREMANGINGO, Ottawa (CA)

(73) Assignee: The Toronto-Dominion Bank, Toronto (CA)

(21) Appl. No.: 17/830,760

(22) Filed: Jun. 2, 2022

(51) Int. Cl. G06Q 20/36; H04L 9/32

(52) U.S. Cl. CPC G06Q 20/3672; H04L 9/3213; H04L 9/3228

(57) ABSTRACT

Systems and methods for providing restricted token usage during an onboarding phase are disclosed. A request to generate a token via an onboarding system may be received from a first entity. A token may then be generated and associated with a special handling instruction to enable temporary usage of the token by the onboarding system but to prevent usage by other systems. The token may then be provided to the first entity via the onboarding system. A change may then be detected in a status of the token. In response to detecting the change in status of the token, the special handling instruction associated with the token may be removed.

### TECHNICAL FIELD

The present disclosure relates to token generation and activation, and, in particular, to systems and methods for providing restricted token usage during an onboarding phase.

### BACKGROUND

Issuer computing systems may receive requests to generate virtual and physical tokens. Such systems may generate a token with a status of “inactive” and may not enable usage of the token until of a change in status to “active” has been detected. The period of time between token generation and token activation may be described as an onboarding phase. It may be desirable to provide systems and methods for provided limited usage of a token during the onboarding phase.

### BRIEF DESCRIPTION OF DRAWINGS

Reference will now be made, by way of example, to the accompanying drawings which show example embodiments of the present application and in which:

FIG. 1 is a schematic diagram illustrating an operating environment of an example embodiment of the present disclosure;

FIG. 2 is a high-level schematic diagram of an example computing device;

FIG. 3 shows a simplified organization of software components stored in memory of the example computing device of FIG. 2;

FIG. 4 shows, in flowchart form, an example method for providing restricted token usage during an onboarding phase; and

FIG. 5 shows, in flowchart form, an example method for processing a request.

Like reference numerals are used in the drawings to denote like elements and features.

### DETAILED DESCRIPTION OF EXAMPLE EMBODIMENTS

In accordance with one aspect of the present application, there is provided a computing system, comprising a processor; a communications module coupled to the processor; and a memory coupled to the processor, the memory storing instructions that, when executed, configure the processor to: receive, from a first entity, a request to generate a token via an onboarding system; generate the token; associate the token with a special handling instruction to enable temporary usage of the token by the onboarding system but to prevent usage by other systems; provide, to the first entity, the token via the onboarding system; detect a change in status of the token; and in response to detecting the change in status of the token, remove the special handling instruction associated with the token.

In some implementations, the change in status of the token is initiated by the first entity.

In some implementations, the removal of the special handling instruction is performed during a robotic process automation (RPA) routine.

In some implementations, the removal of the special handling instruction during the RPA routine is triggered by a detection of the association of the token with the special handling instruction and the detection of the change in status of the token.

In some implementations, the change of status of the token is a cancellation of the token.

In some implementations, the change in status of the token is an activation of the token through an activation system, and the computing system is further configured to: enable broad usage of the token, the broad usage of the token enabling usage by a plurality of systems including the onboarding system and at least some other systems.

In some implementations, the token is a virtual token and the activation of the token through the activation system includes generation of a physical token associated with the virtual token.

In some implementations, the virtual token and the physical token represent a transfer card.

In some implementations, when the token is generated, the transfer card is inactive.

In some implementations, the onboarding system is an e-commerce system.

In accordance with another aspect of the present application, there is provided a computer-implemented method comprising: receiving, from a first entity, a request to generate a token via an onboarding system; generating the token; associating the token with a special handling instruction to enable temporary usage of the token by the onboarding system but to prevent usage by other systems; providing, to the first entity, the token via the onboarding system; detecting a change in status of the token; and in response to detecting the change in status of the token, removing the special handling instruction associated with the token.

In some implementations, the change in status of the token is initiated by the first entity.

In some implementations, the removal of the special handling instruction is performed during a robotic process automation (RPA) routine.

In some implementations, the removal of the special handling instruction during the RPA routine is triggered by a detection of the association of the token with the special handling instruction and the detection of the change in status of the token.

In some implementations, the change of status of the token is a cancellation of the token.

In some implementations, the change in status of the token is an activation of the token through an activation system, and the method may further include: enabling broad usage of the token, the broad usage of the token enabling usage by a plurality of systems including the onboarding system and at least some other systems.

In some implementations, the token is a virtual token and wherein the activation of the token through the activation system includes generation of a physical token associated with the virtual token.

In some implementations, the virtual token and the physical token represent a transfer card.

In some implementations, when the token is generated, the transfer card is inactive.

In accordance with yet another aspect of the present application, there is provided a non-transitory computer readable storage medium containing instructions which, when executed by a processor, cause the processor to: receive, from a first entity, a request to generate a token via an onboarding system; generate the token; associate the token with a special handling instruction to enable temporary usage of the token by the onboarding system but to prevent usage by other systems; provide, to the first entity, the token via the onboarding system; detect a change in status of the token; and in response to detecting the change in status of the token, remove the special handling instruction associated with the token.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

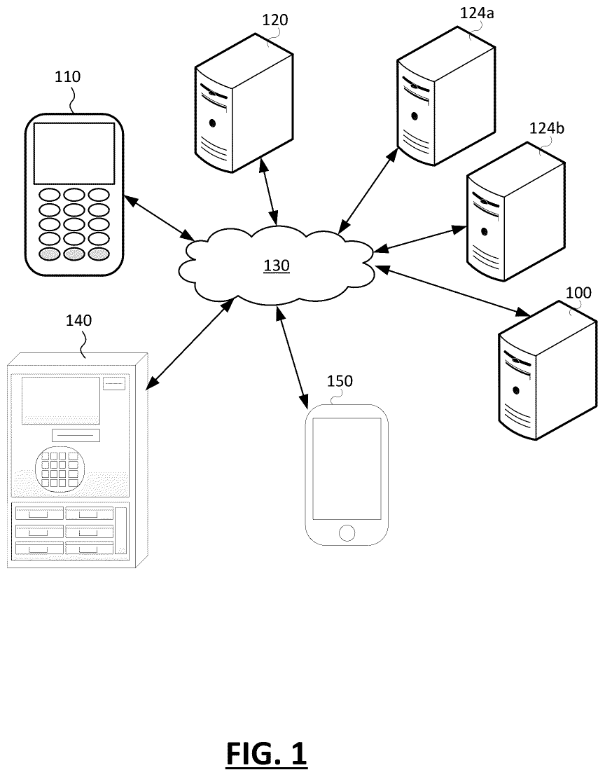

FIG. 1 is a schematic operation diagram illustrating an operating environment of an example embodiment.

As illustrated, a transfer rail server 120 communicates with remote computing devices via a network 130. The remote computing devices may take a variety of forms. For example, as illustrated, the transfer rail server 120 may communicate with one or more point-of-sale (POS) terminals 110, one or more automated teller machines (ATMs) 140, and/or one or more other computing devices such as, for example, one or more transfer initiation systems 124a, 124b. The transfer initiation systems 124a, 124b may be or include, for example, electronic commerce (i.e. e-commerce) systems. An e-commerce system may be, for example, a server associated with an electronic commerce website such as an online store that sells or facilitates the sale of goods and/or services online. In some embodiments, the transfer initiation systems 124a, 124b may be or include, for example, e-commerce systems that facilitate the sale of value transfer cards. A transfer initiation system 124a, 124b which facilitates the sale of value transfer cards may be described as an onboarding system.

The transfer initiation systems 124a, 124b may, additionally or alternatively, include one or more computer systems that are not e-commerce servers. For example, the transfer initiation systems 124a, 124b may be or include utility, subscription, or membership computing systems. For example, the transfer initiation systems may include computing devices associated with one or more of: telephone services, internet services, periodicals including magazines and newspapers, club memberships such as fitness memberships, utility services including, for example, water services, gas services, hydro services, etc.

The transfer rail server 120 may be a computing system that facilitates electronic funds transfer and may, in at least some embodiments, be referred to as a payment rail server. By way of example, the transfer rail server 120 may be a Visa™, Mastercard™, or American Express™ server. The transfer rail server 120 may be associated with a particular brand of value transfer cards. More particularly, the transfer rail server 120 may facilitate payment processing for a particular brand of value transfer card, such as a particular brand of credit and/or charge card. By way of example, in some embodiments, the transfer rail server 120 may only process Visa™ transactions. The transfer rail server 120 may also, in at least some embodiments, be referred to as a credit card network server.

The transfer rail server 120 communicates with a computing system, such as an issuer computing system 100. The issuer computing system 100 may be, for example, a computer system associated with a financial institution, such as a bank, that issued a credit and/or charge card. Put differently, the issuer computing system 100 is associated with a value transfer card issuer. For example, the issuer computing system 100 may be operated or managed by the value transfer card issuer. The issuer computing system 100 may include an activation system providing for the activation and/or cancellation of value transfer cards.

A value transfer card may be or include a payment card (e.g. a credit card, a charge card, etc.). The value transfer card may have certain associated data. For example, the value transfer card may be associated with a primary account number (PAN), a verification number such as a credit card verification (CCV) number, and/or an expiry date. The value transfer card may be used by the point-of-sale terminal 110 or another transfer initiation system 124a, 124b for processing a transfer of value from a cardholder to an entity associated with such systems. The value transfer card may also be used for transactions at an ATM 140. For example, the value transfer card may be inserted into an ATM 140 to start a card session. Upon verification of the cardholder's identity, the cardholder may engage in various transactions (e.g. cash withdrawal, bill payments, etc.) that are available to be performed at the ATM 140.

In order to process a transfer of value using the value transfer card, a POS terminal or other transfer initiation system 124a, 124b may communicate with the transfer rail server 120. For example, the transfer initiation system 124a, 124b may send, to the transfer rail server 120, a transfer request. The transfer request may specify, for example, an amount of value associated with the request. The transfer request may also include or be associated with one or more credentials associated with a value transfer card. The credentials may include, for example, the PAN, expiry date, and/or verification number for the value transfer card. Other metadata may also be included in the transfer request such as, for example, an entity identifier such as a merchant identifier, location information specifying a location at which the transfer initiation system 124a, 124b purports to be located, and/or other information.

The credentials may take other forms. For example, the credentials may include a token. A token may be or include data that is used to represent, by reference, value transfer card data. A token may be connected to one or more accounts (such as banking accounts) that store data and/or resources accessible to the cardholder. By way of example, the token may be associated with a bank account and/or a credit card account.

Tokens may be issued by a tokenization service, which may be included in the transfer rail server 120 or may be a separate system. The tokenization service and/or the transfer rail server 120 stores a mapping of a token to associated information such as, for example, value transfer card data. For example, the token may be mapped to one or more of an account number such as a PAN, a date (e.g. expiry date), verification data (e.g. CCV number), and/or a token holder. The token holder may identify an entity that the token was issued to and/or is associated with. The entity may, for example, be the transfer rail server 120. For example, the transfer rail server 120 may permit one or more third party systems (e.g. the transfer initiation system 124a, 124b) to obtain and store a token for a particular value transfer card. The token is a representation of the value transfer card and may be stored by the transfer initiation system 124a, 124b for future use in issuing value transfer requests. The token may be unique to the entity to which it is issued. That is, different entities that receive tokens for the same value transfer card may receive different tokens, and the transfer rail server 120 and/or the tokenization service may track which entity received which token so that an entity that issued a value transfer request that includes a token may be identified.

Tokens may include physical manifestations. For example, a physical manifestation of a token can be used for making purchases at the point-of-sale terminal 110 or for using the ATM 140. Such tokens may be configured for tap-style payments in which the physical aspect of the token is placed in a communication range of a physical token reader to allow token data to be read from the physical manifestation of the token. By way of example, the physical manifestation of the token may include any one or a combination of: value transfer cards and computing devices having a representation of a payment card stored thereon. By way of example, the physical manifestation of the token may be a mobile device having a mobile wallet that stores a representation of a payment card. Physical tokens may be referred to as value transfer cards in some implementations.

The physical manifestation of token may act as a credit card or a debit card, and may be configured for near-field communication (NFC) payment processing or for wireless communication-based payment processing of another type.

A physical manifestation of a token that has been activated may be referred to as a physical token. A token that is used in the absence of a physical manifestation may be referred to as a virtual token. A virtual token and a physical token may represent a transfer card.

A request to issue a value transfer card may be received by the issuer computing system 100, via an onboarding system, such as a transfer initiation system 124a, 124b, which may be or may include, for example, an electronic commerce (i.e. e-commerce) system. The request may be received from a first entity associated with an account provided by the issuer computing system 100. The account may be associated with a primary account number (PAN).

The request to issue a value transfer card via an onboarding system may include a request to generate a token via an onboarding system. The request may be or may include a request generate a virtual token. The virtual token may represent a transfer card. The request may further include a request to generate a physical manifestation of the token. The physical manifestation of the token may be a value transfer card and the value transfer card may act as a credit card or a debit card.

In some embodiments, the token is generated having a first status of “inactive”. The presence of an “inactive” status may prevent use of the token. Upon receipt of the physical manifestation of the token, a first entity may activate the token through an activation system. In other words, the first entity may initiate a change in the first status of the token from “inactive” to “active”. In some embodiments, the activation of the token through the activation system may enable broad usage of the token, the broad usage of the token may enable usage by a plurality of systems including the onboarding system and at least some other systems. The other systems may include other transfer initiation systems 124a, 124b.

Accordingly, once a token has been associated with an active status, it may be used at many different systems. For example, the active token may be used to process a transfer at systems such as ecommerce systems, point-of-sale terminals, etc.

As noted, in some embodiments, the request to issue a value transfer card via an onboarding system may include a request to generate a virtual token. In some such embodiments, the activation of the token through the activation system may include the generation of a physical token associated with the virtual token. The virtual token and the physical token may represent a transfer card.

In some embodiments, the first entity may cancel the token through the activation system, in other words, the first entity may initiate a change in the status of the token from “inactive” to “cancelled”. In some embodiments, the cancellation of the token through the activation system may disable usage of the token by a plurality of systems including the onboarding system and at least some other systems. The other systems may include other transfer initiation systems 124a, 124b. In at least some implementations, when the status of a token that was once activated changes to inactive or cancelled, it may be rendered unusable at all systems.

Prior to receipt of the physical manifestation of the token, the first entity may wish to use the token. The token may be or include a virtual token. The virtual token may represent a transfer card. To provide for the immediate use of the token, such as the virtual token, by the onboarding system, following generation of the token, the issuer computing system 100 may associate the token with a special handling instruction. The special handling instruction may be a “tiered watch”. The special handling instruction may enable temporary usage of the token by the onboarding system but may prevent usage by other systems. That is, the special handling instruction may configure the token so that it may be used by only a particular system (e.g., the onboarding system) but so that it cannot be used by other systems. Subsequent to the association of the token with the special handling instruction, the issuer computing system 100 may provide, to the first entity, the token via the onboarding system.

For example, the first entity may purchase or otherwise request a value transfer card via a transfer initiation system 124a, 124b, which may be an e-commerce system, such as Amazon™. The purchase or other request of the value transfer card may include a request, from the first entity to generate a token in association with the value transfer card. The issuer computing system 100 may receive the request to generate the token via the e-commerce system and may generate the token. The token may be first generated as a virtual token. The token may have a first status of “inactive”, preventing use of the token. However, the issuer computing system 100 may associate the token with a special handling instruction to enable temporary usage of the token by the e-commerce system, in spite of the token's “inactive” status. Accordingly, the first entity, (who may be a cardholder or other account holder associated with the token), may immediately proceed to use the token at the e-commerce system, while being prevented from using the token at other transfer initiation systems 124a, 124b such as other e-commerce systems.

Following the provision, to the first entity, of the token, in virtual form, via the onboarding system, the issuer computing system 100 may detect a change in status of the token. The change in status of the token may be initiated by the first entity. In some embodiments, the change in status of the token may be a change in the status of the token from “inactive” to “active”.

An “active” status may enable broad usage of the token, the broad usage of the token enabling usage by a plurality of systems including the onboarding system and at least some other systems. In at least some implementations, the change to active status may occur when the first entity has received a physical token that represents the token. That is, when the first entity has received the physical token that is associated with the virtual token, the first entity may activate the token using a computer system to cause the status of the token to be changed to “active.” For example, upon receipt of the physical manifestation of the token, the first entity may activate the token through an activation system. The activation system may be a subsystem of the issuer computing system 100. The activation of the token may occur via the network 130, via a phone network, or via an in-person visit with a representative associated with the activation system which allows the representative to activate the token on the first entity's behalf using a computer. The activation system may be a subsystem of the issuer computing system 100. The activation of the token may represent a change in the status of the token from “inactive” to “active”.

In some embodiments, the change in status of the token may be a change in status of the token from “inactive” to “cancelled”. A “cancelled” status may disable use of the token across a plurality of systems. For example, upon receipt of the physical manifestation of the token, the first entity may cancel the token through the activation system. The cancellation of the token may occur via the network 130, via a phone network, or via an in-person visit with a representative associated with the activation system, which may be a subsystem of the issuer computing system 100. The cancellation of the token may represent a change in the status of the token from “inactive” to “cancelled” or, if the token had already been changed to “active”, from a status of “active” to “cancelled.”

In some embodiments, token data records may be stored as a token data record set in a secure storage of the issuer computing system 100. The token data record set may include token data records for a plurality of tokens. Each token data record of the token data record set may include one or more of an account number such as a PAN, a date such as an expiry date, verification data such as a CCV number, and/or a token holder. The token holder may identify an entity that the token was issued to and/or is associated with, such as the first entity. The first entity may be described as a card holder.

Each token data record of the token data record set may include one or more statuses and may include a special handling instruction. The special handling instruction may enable usage of the respective token at a particular transfer initiation system but prevent usage of the respective token by other systems, and may be described as a “tiered watch”.

Accordingly, in at least some implementations, the statuses described herein represent memory states. For example, a token data record may reflect the status of the token and any change in the status may cause the token data record to be updated.

In response to detecting a change in status of the token, the issuer computing system 100 may remove the special handling instruction from the token. In some embodiments, the removal of the special handling instruction may be performed during a robotic process automation (RPA) routine. In some embodiments, the removal of the special handling instruction during the RPA routine may be triggered by a detection of the association of the token with the special handling instruction and the detection of the change of status of the token. That is, the removal may occur if two preconditions are determined to be met: 1) the token is associated with a special handling instruction; and 2) there has been a change in status of the token. In some implementations, removal of the special handling instruction may be performed as part of a batch process. For example, the issuer computing system may periodically check all tokens to identify any tokens for which the preconditions have been met and may then remove the special handing instruction for such tokens.

After the transfer rail server 120 receives a value transfer request, it may communicate with an issuer computing system 100 to request approval of the value transfer request. The request for approval may include, for example, information included in or obtained from the value transfer request, such as the amount of the value transfer request. The request for approval may include information determined based on the virtual token. For example, the PAN may be included in the request. The transfer rail server 120 receives a response to the request for approval (e.g., either an indication of approval or an indication of denial) and sends a corresponding message to the transfer initiation system 124a, 124b.

Accordingly, a transfer initiation system 124a, 124b may use a credential associated with a value transfer card in order to initiate a transfer. In some instances, the transfer initiation system 124a, 124b may store the credential for future use. For example, the transfer initiation system 124a, 124b may store a representation of a value transfer card in a memory associated with the transfer initiation system 124a, 124b. The representation of the value transfer card may either be a “card-on-file” representation of the value transfer card or a tokenized representation of the value transfer card. In the card-on-file representation, the transfer initiation system 124a, 124b stores the PAN, expiry date and, in some instances, the verification information associated with the value transfer card. In the tokenized representation, the transfer initiation system 124a, 124b stores a token of the type referred to above.

As card holders use their value transfer card with various third-party entities, representations of the value transfer card may be stored at numerous locations. While two transfer initiation systems 124a, 124b are illustrated in FIG. 1, the number of transfer initiation systems 124a, 124b having a stored representation of the value transfer card may be much greater.

The transfer initiation systems 124a, 124b may communicate with the client device 150 via the network 130, and the client device may be associated with the first entity. More specifically, the transfer initiation systems 124a, 124b and the client device 150 may cooperate to provide a user interface on an output device, such as a display, of the client device 150. The first entity may interact with the user interface in order to input instructions to the client device 150. At least some such instructions may cause the client device 150 to send a request to via the transfer initiation systems 124a, 124b to generate a token, and/or to activate and/or to cancel the token through a transfer initiation system 124a, 124b. The user interface may allow the first entity to receive the token via the transfer initiation system 124a, 124b.

The client device 150 may also store the token in secure memory of the client device 150 to allow the client device 150 to be used in initiate a transfer of value. For example, the client device may include a near field communication (NFC) subsystem which may be used to send the token to the point-of-sale terminal 110 in order to initiate or complete a transaction.

The issuer computing system 100, point-of-sale terminal 110, ATM 140, client device 150, transfer initiation systems 124a, 124b, and the transfer rail server 120 may be in geographically disparate locations. Put differently, each of the issuer computing system 100, point-of-sale terminal 110, ATM 140, client device 150, transfer initiation systems 124a, 124b, and the transfer rail server 120 may be remote from others of the issuer computing system 100, client device 150, transfer initiation systems 124a, 124b, and the transfer rail server 120.

The issuer computing system 100, point-of-sale terminal 110, ATM 140, client device 150, transfer initiation systems 124a, 124b, and the transfer rail server 120 may each be both a computer system and a computing device.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, or the like. Additionally, or alternatively, the network 130 may be or may include one or more payment networks. The network 130 may, in some embodiments, include a plurality of distinct networks. For example, communications between certain of the computer systems may be over a private network whereas communications between other of the computer systems may be over a public network, such as the Internet.

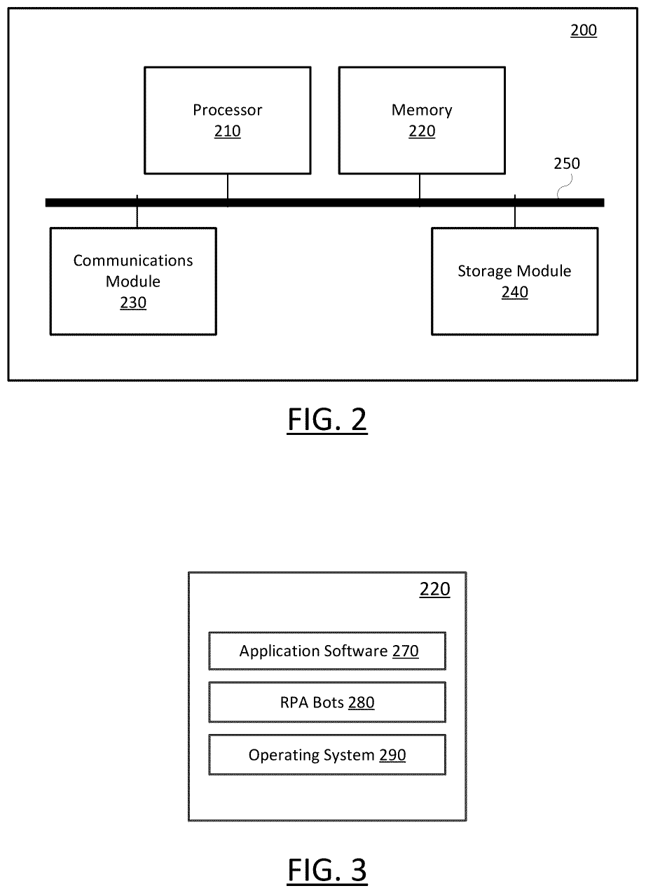

Referring now to FIG. 2, a high-level operation diagram of an example computing device 200 will now be described. The example computing device 200 may be exemplary of the issuer computing system 100, point-of-sale terminal 110, ATM 140, client device 150, transfer initiation systems 124a, 124b, and/or the transfer rail server 120.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The computing device 200 will include other components apart from those illustrated in FIG. 2 and the specific component set may differ based on whether the computing device 200 is operating as the issuer computing system 100, point-of-sale terminal 110, client device 150, transfer initiation systems 124a, 124b, and the transfer rail server 120. For example, the computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the computing devices 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

FIG. 3 depicts a simplified organization of software components stored in memory 220 of the example computing device 200. As illustrated, these software components may include application software 270, robotic process automation (RPA) bot(s) 280, and an operating system 290.

The application software 270 and/or the RPA bot 280 adapts the example computing device 200, in combination with the operating system 290, to operate as a device performing particular functions. While a single application software 270 is illustrated in FIG. 2B, in operation, the memory 220 may include more than one application software 270 and different application software 270 may perform different operations.

In the example of FIG. 3, the example computing device 200 includes one or more RPA bots 280, or software robots, that are executable by a processor (such as processor 210). The RPA bots 280 may be configured to perform various robotic tasks, based on instructions that are defined for the tasks and stored, for example, in the memory 220. An RPA bot 280 may be associated with one or more sub-bots or routines, which may also be stored in the memory 220. Upon completion of a robotic task, the RPA bots 280 may generate specific output(s) or otherwise notify a computing system that the task has been completed.

For example, in some embodiments, the issuer computing system 100 may detect, using a robotic process automation routine, an association of a token with a special handling instruction and a change of status of the token. In at least some embodiments, one or more RPA bots 280 may be employed to operate on the token data record set. In particular, the RPA bots 280 may be configured to detect, for each token data record of the token data record set, the status of each token and the presence of an association with a special handling instruction. The RPA bots 280 may also be configured with an ability to remove special handling instructions from each token data record of the token data record set. The RPA bots 280 may evaluate values of data fields associated with the token data records in order to detect (1) a change of status from “inactive” to either “active” or “cancelled”, and (2) an association with a special handling instruction in connection with a particular token data record.

In some embodiments, upon detecting a change of status and an association with a special handling instruction corresponding to a first token data record, one or more of the RPA bots 280 may remove the special handling instruction from the first token data record.

The operating system 290 is software. The operating system 290 allows the application software 270 and RPA bots 280 to access the processor 210, the memory 220, the storage module 240 and the communications module 230. The operating system 290 may be, for example, Apple iOS™, Google™, Android™, Linux™, Microsoft™, Windows™, or the like.

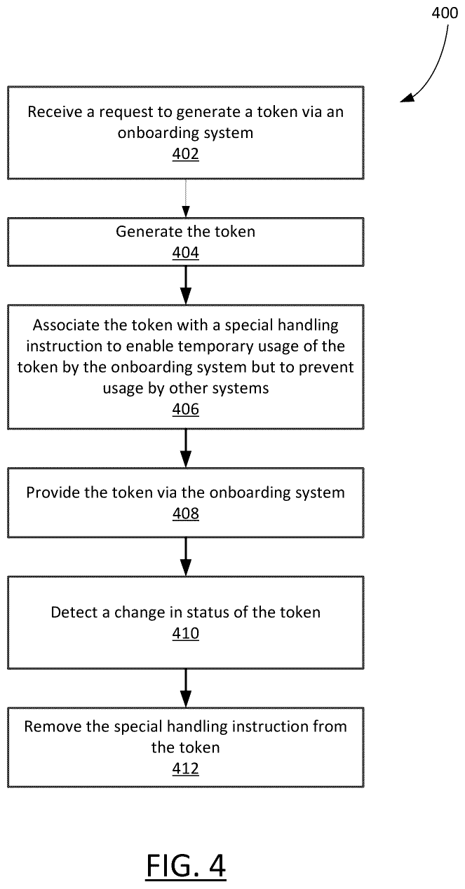

Reference is made to FIG. 4, which shows, in flowchart form, an example method 400 for providing restricted token usage during an onboarding phase.

Operations 402 and onward are performed by one or more processors of a computing device such as, for example, the processor 210 (FIG. 2) of a suitably configured instance of the example computing device 200 (FIG. 2). The method 400 may be performed, for example, by a computing device such as the issuer computing system 100 (FIG. 1).

At operation 402, the issuer computing system receives, from a first entity, a request to generate a token via an onboarding system. In some embodiments, the onboarding system may be a transfer initiation system, such as an e-commerce system, and the first entity may be associated with an account associated with the issuer computing system. In some embodiments, the request to generate a token may be included in a request to issue a value transfer card.

By way of example, it may be that the transfer initiation system communicates with a client device associated with the first entity. The transfer initiation system may receive, from the client device, an instruction to obtain a token and/or an instruction to issue a value transfer card. This instruction may be received, for example, via an interface provided by the transfer initiation system. The interface may be, for example, a checkout interface that allows the first entity to complete a checkout.

When the transfer initiation system receives the instruction, it may communicate with the issuer computing system 100. For example, the transfer initiation system may send a request to generate a token to the issuer computing system 100. The issuer computing system 100 may receive this request via a communication module, which may include a hardware communication device such as a communication chip.

The request may be or may include a request to generate a virtual token. Additionally or alternatively, the request may be or may include a request to generate a physical manifestation of the token. In at least some implementations, the request may include both a request to generate a virtual token and a request to generate a physical manifestation of the token (i.e., a physical token).

The request may be provided by way of a signal that represents the request. The request may, in at least some implementations, be a device-to-device message. For example, the request may be an electronic message. The request may be, in some implementations, be provided as a call to an application programming interface (API) associated with the issuer computing system 100. That is, the issuer computing system 100 may receive the request via an API.

As noted, in some implementations, the physical manifestation of the token may include a value transfer card and the value transfer card may act as a credit card or a debit card.

At operation 404, the issuer computing system 100 generates the token. In some embodiments, the token is generated having a first status of “inactive”. That is, the issuer computing system 100 may configure a status in memory which is to be associated with the token so that the status is set to inactive at the operation 404. The presence of an “inactive” status may prevent use of the token.

A token is data that may be used to authorize an action, such as a transfer and the status associated with that token may control whether the token may or may not be used. For example, the status may be considered by the issuer computing system 100 when the issuer computing system 100 receives a transfer request that requests a transfer to be initiated using the token. For example, when the status is inactive, a transfer will not generally be permitted using the token unless a special handling instruction is in place to override the inactive status of the token to allow certain transfers to occur. When the status is set to active, the token may generally be used to initiate a transfer, even if a special handling instruction is not in place.

The request to generate a token may be or may include a request to generate a virtual token. A virtual token is a token that is provided electronically to a recipient system and that may be stored in memory of the recipient system.

The request may further include a request to generate a physical manifestation of the token. A physical token or a physical manifestation of the token may be a token that is encoded on a physical card or other instrument. For example, the card may include memory that stores the token. For example, the physical manifestation of the token may be or include a value transfer card and the value transfer card may act as a credit card or a debit card.

At operation 406, the issuer computing system obtains a token and associates the token with a special handling instruction to enable temporary usage of the token by the onboarding system. In some embodiments, the special handling instruction may be described as a “tiered watch”. The special handling instruction may enable immediate, temporary usage of the token by the onboarding system but may prevent usage by other systems. The issuer computing system may associate the virtual token with the special handling instruction so that the virtual token may be used in a limited manner.

By allowing immediate limited usage of a token, the issuer computing system may allow a token to be used in a limited manner while the entity associated with that token awaits a physical token. This may simplify the issuing process by allowing physical token creating systems to be located more centrally since there is less of a need to provide a physical token immediately when the virtual token may be used in at least some manner prior to the entity's receipt of the physical token.

The token may, in at least some implementations, be obtained at the operation 406 via a token service provider (TSP). The TSP may include an interface such as an API and the issuer computing system may obtain the token via the interface. The issuer computing system may associate the token with an account, such as an account associated with the first entity.

At operation 408, the issuer computing system provides, to the first entity, the token via the onboarding system. The token may be a virtual token. In some embodiments, the token may be stored in secure memory of a client device associated with the first entity to allow the client device to be used to initiate a transfer of value. In some embodiments, the token may be stored in memory of the onboarding system to allow the token to be used for transfers initiated from the onboarding system.

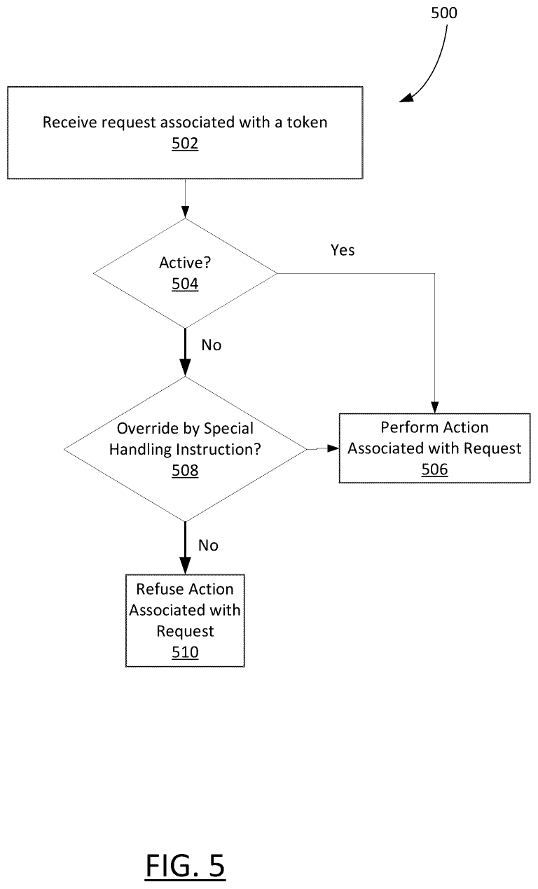

After the token has been provided to the onboarding system it may be used to process a transfer. Examples of how a transfer may be processed using a token will be described in greater detail below with reference to FIG. 5.

At operation 410, the issuer computing system detects a change in status of the token. The change of status of the token may be initiated by a computing device under direction or control of the first entity. For example, in some embodiments, upon receipt of a physical manifestation of the token, the first entity may activate the token through an activation system, which may, for example, be a subsystem of the issuer computing system. In other words, the first entity may cause the issuer computing system 100 to initiate a change in the first status of the token from “inactive” to “active”. The first entity may, for example, control a client device that is in communication with the issuer computing system 100 to request activation of the token. The issuer computing system 100 may then update a status associated with the token in memory to indicate that the token is now “active”.

In some embodiments, the activation of the token through the activation system may enable broad usage of the token. Broad usage of the token may enable usage of the token by a plurality of systems including the onboarding system and at least some other systems. The other systems may include other transfer initiation systems. For example, as will be explained in greater detail below with reference to FIG. 5, when the token has been activated, it may be used by many different transfer initiation systems, including at least one transfer initiation system that was not the onboarding system.

In at least some implementations, activation affects both the physical token and the virtual token simultaneously. These tokens are related and are, in some instances, the same data or they include at least some common data.

The activation of the token may occur via a computer network, via a phone network, or via an in-person visit with a representative associated with the activation system.

In some embodiments, upon receipt of a physical manifestation of the token, the first entity may cancel the token through an activation system, which may, for example, be a subsystem of the issuer computing system. In other words, the first entity may initiate a change in the first status of the token from “inactive” to “cancelled” or “disabled”. Or, if the first entity had already activated the token, then it may change the status from “active” to “cancelled”. In some embodiments, the cancellation of the token through the activation system may disable usage of the token by a plurality of systems including the onboarding system and at least some other systems. The other systems may include other transfer initiation systems. In at least some implementations, cancellation of the token may render the token unusable by all transfer initiation systems.

The cancellation of the token may occur via a computer network, via a phone network, or via an in-person visit with a representative associated with the activation system.

At operation 412, in response to detecting the change in status of the token, the issuer computing system removes the special handling instruction from the token. The removal of the special handling instruction may be performed during a robotic process automation (RPA) routine. In some embodiments, the removal of the special handling instruction during the RPA routine is triggered by a detection of the association of the token with the special handling instruction and the detection of the change in status of the token.

In at least some implementations, the special handling instruction represents computer executable instructions and the removal of the special handling instruction may involve deleting the computer executable instructions or deleting a reference that associates the computer executable instructions with the token.

In some embodiments, token data records may be stored as a token data record set in a secure storage of the issuer card system. The token data record set may include token data records for a plurality of tokens. Each token data record of the token data record set may include one or more of an account number such as a PAN, a date such as an expiry date, verification data such as a CCV number, and/or a token holder. The token holder may identify an entity that the token was issued to and/or is associated with, such as the first entity. The first entity may be described as a card holder.

Each token data record may include one or more statuses and may include a special handling instruction, when the special handling instruction has been enabled for the associated token. The special handling instruction may enable usage of the respective token at a particular transfer initiation system but prevent usage of the respective token by other systems. In at least some implementations, the special handling instruction may be or represent a “tiered watch”. In some embodiments, a robotic process automation (RPA) routine may operate to remove the special handling instructions from certain token data records when certain conditions are determined to have been satisfied. For example, in some embodiments, the issuer computing system may detect, using an RPA routine, (1) a change in status, and (2) an association with a special handling instruction in connection with a first token data record in the token data record set. In at least some embodiments, one or more RPA bots may be employed to operate on the token data record set. In particular, the RPA bots may be configured to detect, for each token data record of the token data record set, a change of status from “inactive” to “active” or “cancelled” and the presence of an association of with a special handling instruction. The RPA bots may also be configured to remove special handling instructions from each token data record of the token data record set. The RPA bots are software components, or modules, that are associated with the issuer computing system. For example, the RPA bots may comprise software instructions that are stored in a memory associated with the issuer computing system. The RPA bots may evaluate values of data fields associated with the token data records in order to detect a changes in status from “inactive” to “active” or “cancelled” and associations with a special handling instruction.

In some embodiments, upon detecting both a change in status and an association with a special handling instruction in connection with a first token data record in the token data record set, one or more RPA bots may remove the special handling instruction from the first token data record.

Reference is made to FIG. 5, which shows, in flowchart form, an example method 500 for providing restricted token usage during an onboarding phase.

Operations 502 and onward are performed by one or more processors of a computing device such as, for example, the processor 210 (FIG. 2) of a suitably configured instance of the example computing device 200 (FIG. 2). The method 500 may be performed, for example, by a computing device such as the issuer computing system 100 (FIG. 1).

The method 500 may be performed to process a request. For example, at an operation 502, the issuer computing system 100 may receive a request. The request may be received via a communication module. In some implementations, the request may be received via a network. The request may be received from a transfer initiation system. The transfer initiation system may be or include the onboarding system that caused the token to be obtained at the method 400 or it may be received from another transfer initiation system.

The request may be a request to perform an operation. The operation may, in at least some implementations, only be performed by the token-holder. Accordingly, the request may include a representation of the token. The representation of the token may be the token (e.g., it may be the data stored in memory that represents the token) or it may be a portion of the token or it may be data that is determined from the token.

In some implementations, the operation may be a transfer. The transfer may be a transfer of resources. In at least some such implementations, the request may define an amount of resources that are to be transferred.

In at least some implementations, the request may include a requestor identifier. The requestor identifier may identify the particular system that initiated the request.

The issuer computing system 100 may either perform the requested action or operation or it may not perform the requested action or operation. The issuer computing system 100 may determine whether or not the operation is to be performed based, at least in part, on a status identifier associated with the token. For example, the issuer computer system 100 may, at the operation 504, determine whether the token is active. This determination may be made based on a status indicator defined in memory. Accordingly, at an operation 504, the issuer computing system 100 may determine whether the token associated with the request is active. If so, the issuer computer system 100 may, at an operation 506, perform an action or operation associated with the request. For example, where the request is a request to transfer, the issuer computer system 100 may initiate a transfer. The transfer may be a transfer of resources and the transfer may be initiated by updating a ledger to reflect the transfer of resources.

If, however, the issuer computing system 100 determines at the operation 504 that the token is inactive, then it may, at an operation 508, determine whether a special handling instruction applies. The special handling instruction may, in some implementations, apply when the requestor that issued the request at the operation 502 is determined to be the onboarding system that caused the token to be obtained during the method 400. If the special handling instruction applies, then the issuer computing system may apply the special handling instruction. For example, the issuer computer system 100 may, at an operation 506, perform an action or operation associated with the request.

If, however, the special handling instruction does not apply, then the issuer computing system may, at an operation 510, deny the request. That is, the issuer computing system may refuse the action or operation associated with the request. If, for example, the request is a transfer request, then the transfer may be denied.

The techniques described herein may be used with tokens that represent value transfer cards but they may also be used for other tokens that allow access to a restricted operation. That is, they may be used to allow any computing operation requiring a token to be selectively performed.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a communications module coupled to the processor; and
a memory coupled to the processor, the memory storing instructions that, when executed, configure the processor to:
receive, from a first entity, a request to generate a token via an onboarding system;
generate the token;
associate the token with a special handling instruction to enable temporary usage of the token by the onboarding system but to prevent usage by other systems;
provide, to the first entity, the token via the onboarding system;
detect a change in status of the token; and
in response to detecting the change in status of the token, remove the special handling instruction associated with the token.

2. The computing system of claim 1, wherein the change in status of the token is initiated by the first entity.

3. The computing system of claim 1, wherein the removal of the special handling instruction is performed during a robotic process automation (RPA) routine.

4. The computing system of claim 3, wherein the removal of the special handling instruction during the RPA routine is triggered by a detection of the association of the token with the special handling instruction and the detection of the change in status of the token.

5. The computing system of claim 1, wherein the change of status of the token is a cancellation of the token.

6. The computing system of claim 1, wherein the change in status of the token is an activation of the token through an activation system, and wherein the computing system is further configured to:
enable broad usage of the token, the broad usage of the token enabling usage by a plurality of systems including the onboarding system and at least some other systems.

7. The computing system of claim 6, wherein the token is a virtual token and wherein the activation of the token through the activation system includes generation of a physical token associated with the virtual token.

8. The computing system of claim 7, wherein the virtual token and the physical token represent a transfer card.

9. The computing system of claim 8, wherein when the token is generated, the transfer card is inactive.

10. The computing system of claim 1, wherein the onboarding system is an e-commerce system.

11. A computer-implemented method comprising:
receiving, from a first entity, a request to generate a token via an onboarding system;
generating the token;
associating the token with a special handling instruction to enable temporary usage of the token by the onboarding system but to prevent usage by other systems;
providing, to the first entity, the token via the onboarding system;
detecting a change in status of the token; and
in response to detecting the change in status of the token, removing the special handling instruction associated with the token.

12. The method of claim 11, wherein the change in status of the token is initiated by the first entity.

13. The method of claim 11, wherein the removal of the special handling instruction is performed during a robotic process automation (RPA) routine.

14. The method of claim 11, wherein the removal of the special handling instruction during the RPA routine is triggered by a detection of the association of the token with the special handling instruction and the detection of the change in status of the token.

15. The method of claim 11, wherein the change of status of the token is a cancellation of the token.

16. The method of claim 11, wherein the change in status of the token is an activation of the token through an activation system, and wherein the method further comprises:
enabling broad usage of the token, the broad usage of the token enabling usage by a plurality of systems including the onboarding system and at least some other systems.

17. The method of claim 16, wherein the token is a virtual token and wherein the activation of the token through the activation system includes generation of a physical token associated with the virtual token.

18. The method of claim 17, wherein the virtual token and the physical token represent a transfer card.

19. The method of claim 18, wherein when the token is generated, the transfer card is inactive.

20. A non-transitory computer readable storage medium containing instructions which, when executed by a processor, cause the processor to:
receive, from a first entity, a request to generate a token via an onboarding system;
generate the token;
associate the token with a special handling instruction to enable temporary usage of the token by the onboarding system but to prevent usage by other systems;
provide, to the first entity, the token via the onboarding system;
detect a change in status of the token; and
in response to detecting the change in status of the token, remove the special handling instruction associated with the token.
